(19) United States
(12) Patent Application Publication
(10) Pub. No.: US 2008/0129444 A1
(43) Pub. Date: Jun. 5, 2008

(54) Wireless Security System

(76) Inventor: Shary Nassimi, Malibu, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/565,746

(22) Filed: Dec. 1, 2006

(51) Int. Cl. G08C 19/00; G08C 19/16; H04B 1/00

(52) U.S. Cl. 340/5.2; 340/5.1

(57) ABSTRACT

A wireless system for granting or denying access to protected location or equipment and providing compatibility with existing access point devices and control equipment. The system is based on a remote wireless unit positioned at each protected location and interfaced with security hardware at the location, such as a keypad. The remote unit is provided access to the data entered by a user trying to gain access, packaged with an electronic location identification code, and wirelessly transmitted to a central unit. The central unit is interfaced with a central computer and interprets the location identification code. The central computer may then determine whether or not to grant access based on the data entered at the remote location and the location identification provided by the remote unit. The central unit then transmits the determination back to the remote location along with the identification code. The remote unit provides the determination to the security hardware if the location code is applicable.

### BACKGROUND OF THE INVENTION

1. Field of the Invention

The present invention relates to access control systems and, more particularly, to a system for wirelessly controlling access to multiple remote locations.

2. Description of the Related Art

Conventional systems for securely monitoring and controlling points of entry and access points generally require the placement of a monitoring device, such as a password accepting keypad, security card reader, or locking mechanism, at every possible point of entry or point of access that is to be secured by the system. Each monitoring device is interconnected to central database or control center via wires extending from the monitoring device through the building or enclosure to the control center. The wires are typically routed through an access panel at the control center having an input/output port for each location secured by the monitoring device. The conventional method of electrically wiring all of the monitoring devices to a central location that confirms the identity and/or authorization of a user's access at each point of entry of access is commonly referred to as a “home run” system.

When an authorized user accesses a location by inputting information into the monitoring device, whether by scanning a smart card, typing in a password into a keypad, etc., the inputted information is communicated through the wiring directly to the central control center. The central control center references the inputted data against a previously stored list of acceptable passwords or identities in a database, verifies that the user has inputted the appropriate information, and then generates a return signal to the monitoring device to allow access at the point of entry or access, such as unlocking a door or permitting use of secure equipment. The generally accepted protocol for these electronic communications is known as Wiegand, although other known data transmission protocols may been used.

Security systems, such as “home run” systems, thus require that copious amounts of wiring be installed to permit the central control center to communicate with independently with each of the monitoring devices and associated switching systems to permit access to the remotely positioned equipment or locations. In the case of new construction, the wiring for the system and the labor associated with installation can be very costly. In existing buildings or structures, installation of the necessary wiring may be even more costly, due to the additional requirement the wiring be retrofit into preexisting building materials. These systems are also difficult to debug or repair in the event that the wiring is damaged or becomes corrupt because the wiring is usually hidden within the support structure and walls of the building.

### BRIEF SUMMARY OF THE INVENTION

It is therefore a principal object and advantage of the present invention to provide a system for monitoring and controlling secure points of entry and access points that avoids the need to install wires to every access point or point of entry.

It is a further object and advantage of the present invention to provide a system for monitoring and controlling secure points of entry and access points that is easily installed.

It is an additional object and advantage of the present invention to provide a system for monitoring and controlling secure points of entry and access points.

It is also object and advantage of the present invention to provide a system for monitoring and controlling secure points of entry and access points that that is less costly.

It is another object and advantage of the present invention to provide a system for monitoring and controlling secure points of entry and access points that works with existing systems and hardware.

In accordance with the foregoing objects and advantages, the present invention provides a system for managing secure access points comprising a wireless transceiver associated with each monitoring device located at the points of entry and access points that communicates with a central transceiver located at a control center. Each wireless transceiver located at the entry or access point is capable of transmitting access information received by the monitoring devices to the central transceiver, where it is compared by the control center to previously stored information to determine whether access should be granted or denied. In addition to transmitting the access information received by the monitoring devices, the wireless transceivers append a predetermined identification code that signifies the location of wireless transceiver and entry or access location. The data transmitted by the wireless transceivers is thus capable of signifying the location of the monitoring device where access has been sought, along with the identity of the user attempting access. The determination of the control center whether access should be granted is wirelessly transmitted in return by the central transceiver along with the particular identification code of the requesting wireless transceiver. While every wireless transceiver located at each entry point may receive the command signal from the central transceiver, only the requesting device will accept the command coming from the central transceiver.

### BRIEF DESCRIPTION OF THE DRAWINGS

The present invention will be more fully understood and appreciated by reading the following Detailed Description in conjunction with the accompanying drawings, in which:

FIG. 1 is schematic of a system according to the present invention.

FIG. 2 is a schematic of a wireless transceiver according to the present invention.

FIG. 3 is a schematic of a central transceiver according to the present invention.

FIG. 4 is a flowchart of a process according to the present invention.

FIG. 5 is a schematic of an alternate embodiment according to the present invention.

### DETAILED DESCRIPTION OF THE INVENTION

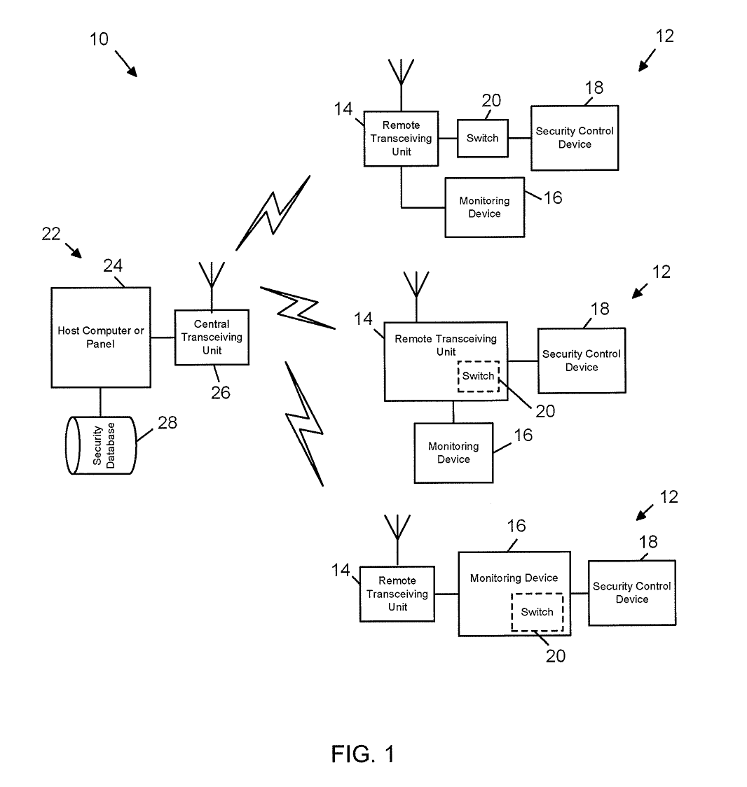

Referring now to the drawings, wherein like reference numerals refer to like parts throughout, there is seen in FIG. 1 a wireless security system 10 according to the present invention. System 10 generally comprises any number of remote locations 12, each of which preferably includes a remote transceiver unit 14, a monitoring device 16 interconnected to the remote transceiver unit 14, and a point of entry or access security control device 18 interconnected to remote transceiver unit 14 and/or monitoring device 16. Monitoring device 16 accepts data indicative of a user attempting to gain access, and thus may comprise keypad, an identification card reader, a remote receiver (such as an radiofrequency or infrared receiver), a biometric reader, such as a fingerprint or retina scanner, or other device that receive an input of data from user, whether in the form of direct data entry or a signal. Access control device 18 may comprise an electric door strike, or any other electrically actuated means of controlling entry or access to a location or particular piece of equipment or device. Remote location 12 further includes a switch 20 or comparable structure for executing instructions to grant or deny access, such as a relay, that actuates security control device 18.

System 10 further comprises a control center 22 including a host device 24 interconnected to a central transceiver unit 26 and a security database 28. Host device 24 may comprise any form of security determining hardware or software, or a combination thereof. For example, host device 24 may comprise a conventional Wiegand access panel or hub having a plurality of data input/output (I/O) ports for interconnecting to devices using a comparable protocol. Host device 24 may be programmable or non-programmable, but is preferably capable of executing logic or decision-making switching to determine whether access should be granted to a user inputting data or otherwise requesting access at remote location 12. System 10 is designed to operate with anything from the least sophisticated host devices, such as access panels having databases of acceptable users/passwords to sophisticated computer systems capable of interfacing with the internet to access remote databases or receive instructions on whether to grant access.

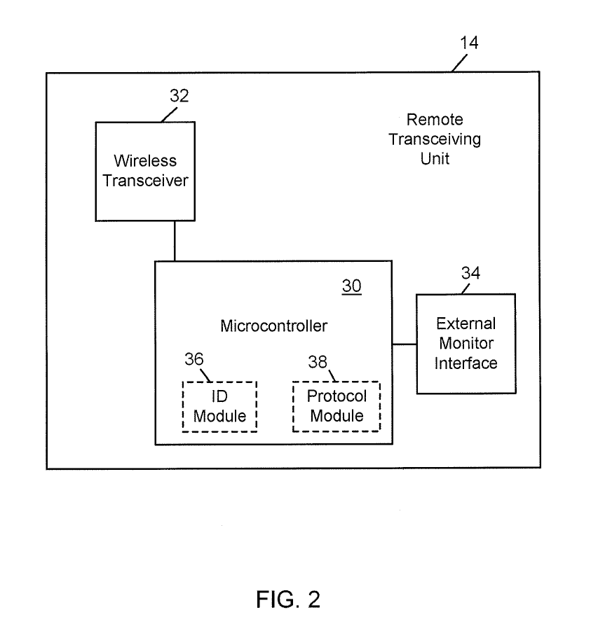

Referring to FIG. 2, remote transceiver unit 14 comprises a remote microcontroller 30 interconnected to a wireless transceiver 32 and a monitor interface 34. Remote microcontroller 30 may comprise an ATmega8 available from Atmel Corporation of San Jose, Calif. and includes the following features: 8 K bytes of In-System Programmable Flash with Read-While-Write capabilities, 512 bytes of EEPROM, 1 K byte of SRAM, 23 general purpose I/O lines, 32 general purpose working registers, three flexible Timer/Counters with compare modes, internal and external interrupts, a serial programmable USART, a byte oriented Two-wire Serial Interface, a 6-channel ADC (eight channels in TQFP and QFN/MLF packages) with 10-bit accuracy, a programmable Watchdog Timer with Internal Oscillator, an SPI serial port, and five software selectable power saving modes. Wireless transceiver 32 may comprise an ADF 7020 available from Analog Devices of Norwood, Mass., and is a low power, low-IF transceiver designed for operation in the license-free ISM bands at 433 MHz, 868 MHz and 915 MHz. As seen in FIG. 1, remote transceiver unit 14 may further include switch 20 internally for actuating security device 18 and thereby granting or denying access to the protected location or equipment. As further seen in FIG. 1, remote transceiver unit 14 may instead be interconnected to an external switch 20 for operating security device 18. Alternatively, as also seen in FIG. 1, monitoring device 16 (or even security device 18) may be provided switch 20 that is actuated by a signal or data provided by remote transceiver unit 14, thereby granting or denying access to remote location 12.

Remote microcontroller 30 further comprises an identification module 36 and a protocol module 38, although those of skill in the art will recognize that the modules could be implemented in separate processors or firmware. Identification module 36 is programmed to generate or retrieve a predetermined identification code or indicia representative of a particular remote location, i.e., the location of monitoring device 16 associated remote transceiver unit 14. The identification code may be predetermined and programmed into remote microcontroller 30, selected by the use of a dip switch (not shown), remotely transmitted to remote microcontroller 30, or any various combination thereof. Monitor interface 34 may comprise a conventional RS232 transceiver and associated 12 pin FFC jack. Alternatively, monitor interface 34 may comprise other conventional buses, such as USB, IEEE, 1394, IrDA, PCMCIA, or Ethernet (TCP/IP). Monitor interface 34 may also comprise a wireless transceiver for wireless communication to monitoring device 16. Protocol module 38 is programmed to recognize the particular protocol employed by monitoring device 16 and monitor interface 34 for receiving and transmitting electronic data to and from monitoring device 16. Preferably, protocol module 38 is programmed to send and receive data in the Wiegand protocol commonly used by commercially available monitoring devices 16.

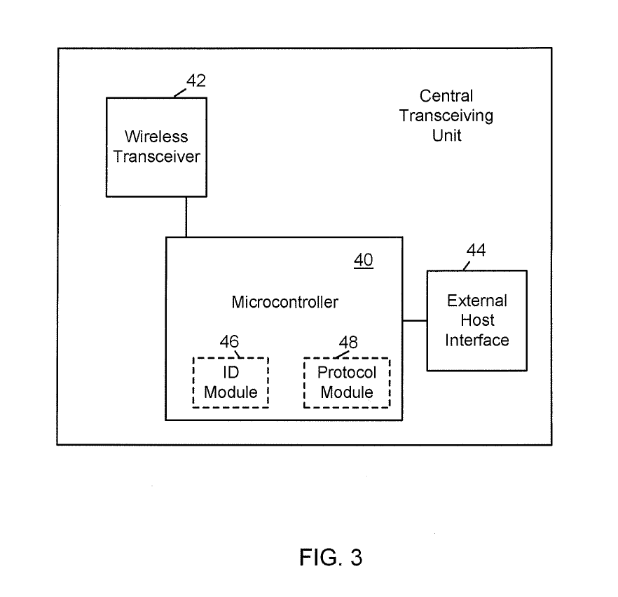

Referring to FIG. 3, central transceiver unit 26 comprises a central microcontroller 40 interconnected to a wireless transceiver 42 and a host interface 44. Central microcontroller 40 may comprise an ATmega8 available from Atmel Corporation of San Jose, Calif. Wireless transceiver 42 may comprise an ADF 7020 available from Analog Devices of Norwood, Mass., and is a low power, low-IF transceiver designed for operation in the license-free ISM bands at 433 MHz, 868 MHz and 915 MHz. Host interface 44 may comprise a conventional RS232 transceiver and associated 12 pin FFC jack. Alternatively, host interface 44 may comprise other conventional buses, such as USB, IEEE, 1394, IrDA, PCMCIA, or Ethernet (TCP/IP). Host interface 44 may also comprise a wireless transceiver for wireless communication to host device 24. Central microcontroller 40 further comprises an identification module 46 and a protocol module 48, although those of skill in the art will recognize that the modules could be implemented in separate processors or firmware. Protocol module 48 is programmed to recognize the particular protocol employed by monitoring device 16 and is preferably programmed to send and receive data in the Wiegand protocol. Identification module 46 is programmed to interpret the identification code retrieved or generated by identification module 36 and associate the particular identification code with the location it represents. Accordingly, identification module 46 preferably includes or has access to a database for storing a plurality of identification codes along with indicia representing the particular location using each identification code. Identification module 46 may further be programmed to generate identification codes for each location, store the codes and associated location in a database, and transmit the identification codes to each remote location 12 for storage by identification module 36. It should be recognized by those of skill in the art that the identification code for each remote location 12 may be changed at any time, or after the expiration of a set period of time, such as hourly, daily, or weekly.

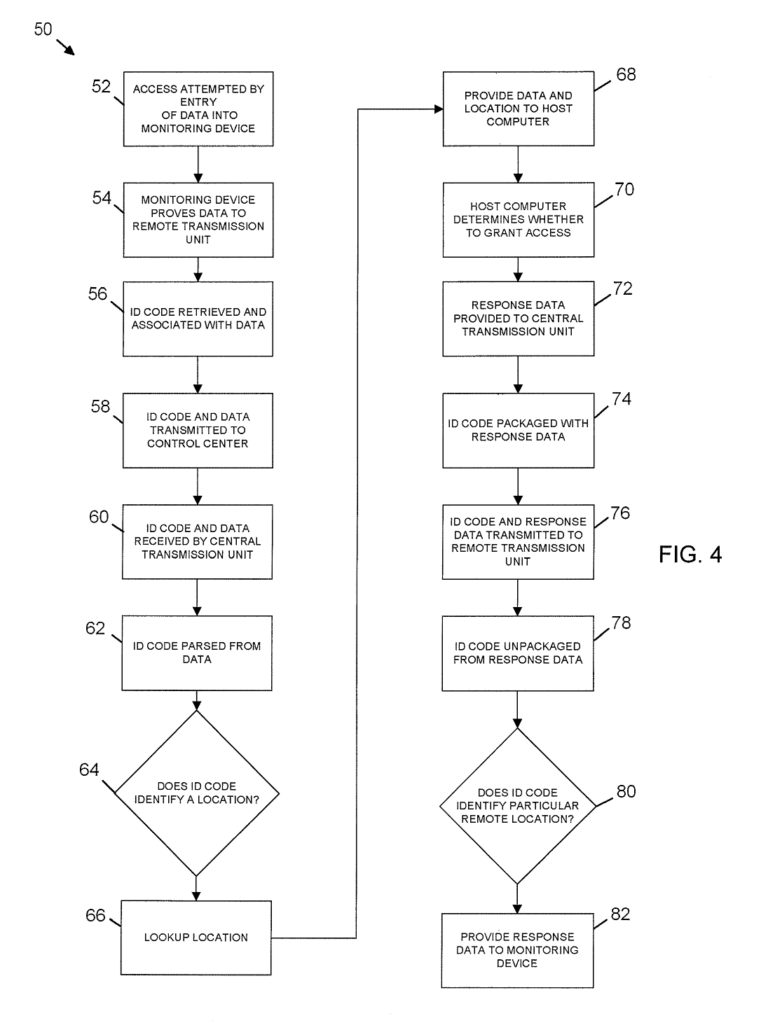

There is seen in FIG. 4, a preferred embodiment of an access control process 50 employed by system 10. First, a visitor or user attempts to access 52 one remote location 12 protected by point of entry control device 18 and/or point of access control device 20 by entering data into monitoring device 16, such as by typing a password into a keypad, swiping a smart card previously programmed with a password or other identifying data in predetermined protocol or placing a finger on a biometric reader. Data obtained by monitoring device 16 is passed 54 to remote transceiver unit 14 in a standard protocol, such as Wiegand format, for wireless transmission to control center 22. Prior to transmitting the data, remote transceiver unit 14 retrieves the appropriate identification code representing remote location 12 and then associates the identification code 56 with the data obtained by monitoring device 16. The data and the identification code are then transmitted 58 to control center 22 by remote transceiver unit 14 in the appropriate digital format, preferably using an encrypted or secure format. The data and the identification code may be combined into a single packet and transmitted, or transmitted in series of packets. If the data and identification code are transmitted in a serious of packets, the packets may be spaced apart according to a predetermined time period, thereby ensuring proper recognition by control center 22 and providing security. Central transceiver unit 26 receives the packet (or packets) 60 including the data and identification code, interprets the protocol, and parses out the identification code 62 from the data that was entered into monitoring device 16. Using identification module 46, central transceiver unit 26 verifies 64 that a proper identification code has been transmitted, optionally stores the identification code is temporary memory for a predetermined time, looks up the location associated with the identification code 66, and provides the data and the location information to the host device (in this preferred embodiment host computer 24) in an industry standard format, such as Wiegand format. In the event that multiple remote locations 12 are transmitting to control center 22, central transceiver unit 26 may temporarily store incoming identification codes in a stack for subsequent reference.

Host computer 24 may then determine 70 whether the user or visitor at remote location 12 is to be allowed or denied access to remote location 12. When host computer 24 makes its determination, it provides the appropriate response data 72 to central transceiver unit 26 in the form of a relay closure, digital signal, or packet of data in a predetermined protocol, such as Wiegand protocol. Host computer 24 preferably includes location information as part of the response data, thereby allowing central transceiver unit 26 to retrieve the appropriate identification code stored in temporary memory. The response data and identification code are then packaged together 74, as described earlier with respect to data entered by a user, and transmitted 76 to remote location 12 for receipt by remote transceiver unit 14. Remote transceiver unit un-packages the response data and identification code 78, verifies that the identification code matches the location 80 and, if so, provides the response data 80 to monitoring device 16. Monitoring device 16 may then execute the appropriate response via point of entry control device 18 and/or point of access control device 20, such as unlocking the door, allowing use of secure equipment, etc. Alternatively, a relay or switch 20 provided as part of remote transceiver unit 14 may be activated according to the response data to directly grant or deny access to the access point or secure location. System 10 thus allows multiple remote locations 12 to be securely protected without the need for any cabling or hard wiring from remote locations 12 to control center 22, and control center 22 only requires a single transceiver to control operation of multiple remote locations 12.

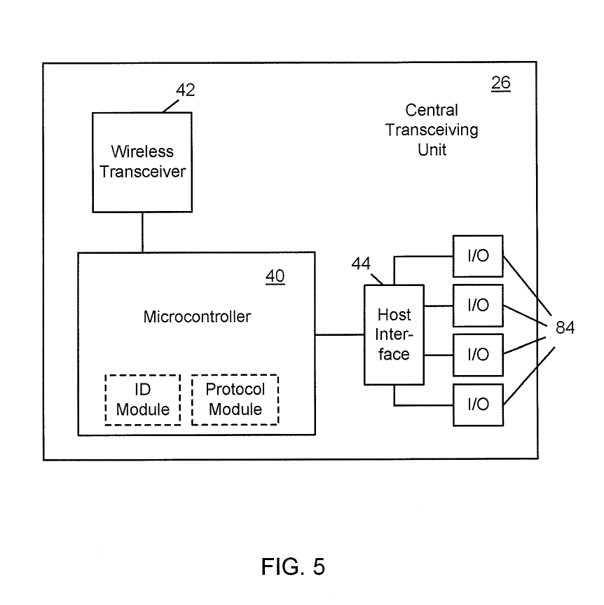

As described above, a single interface 44 may be used for transmission of data between central transceiver unit 26 and host device 24. Referring to FIG. 5, in an alternate embodiment of the present invention, central transceiver unit 26 may be interconnected with host computer 24 via multiple I/O interfaces 84, such as Wiegand protocol based connections. As existing control centers 22 may include host devices 24 having separate input and output data lines for location and access information, central transceiver unit 26 may be provided with matching I/O interfaces that separate the location information data from the access data, and are dedicated as either input or output lines, or both. When single interface 44 is interconnected to control panel or host device 24, any variety of method may be used. For example, if control panel or host device 24 is programmable, single interface 44 need only be interconnected to a single I/O port or pair of ports previously dedicated to a single remote location 12. Control panel or host device 24 may then be reprogrammed to look for location and data information only from the single port of pair of ports. If control panel or host device 24 is not programmable, however, single interface 44 may be provided with I/O interfaces 84 for connection to each I/O port of control panel or host device 24 and central microcontroller 40 may be programmed to report the access data to the appropriate I/O ports for the location identified by the ID code received from remote location 12. In either case, only a single central transmitter of system 10 is needed to provide wireless control of a plurality of remote locations 12, thereby avoiding the need to hard wire each remote location 12, or having to provide a pair of transmitters for wirelessly controlling each remote location 12 and then having to wire one of each pair to host device 24. In this manner, the present invention may used to retrofit existing access control systems to eliminate the need for wiring, or may used in connection with off-the-shelf central control hardware.

What is claimed is:

1. A security system, comprising:
a plurality of wireless transceiving units, each of which positioned at a predetermined location; and
a single central transceiving unit positioned remotely from each of said predetermined locations for communicating wirelessly with each of said plurality of wireless transceiving units.

2. The system of claim 1, wherein each of said plurality of wireless transceiving units is programmed to receive data from by a security device interconnected thereto.

3. The system of claim 2, wherein each of said plurality of wireless transceiving units is programmed to append data representing said predetermined location to said data supplied by said security device.

4. The system of claim 3, wherein each of said plurality of wireless transceiving units is programmed to transmit said data representing said predetermined location and said data supplied by said security device to said central transceiving unit.

5. The system of claim 4, wherein said central wireless transceiving unit is programmed to identify said predetermined location based on wireless receipt of said data representing said predetermined location.

6. The system of claim 5, wherein said central wireless transceiving unit is programmed to output the identity of said predetermined location along with said data supplied by said security device.

7. A security system, comprising:
a plurality of security devices, each of which is positioned at a predetermined location;
a plurality of wireless transceiving units, each of which is interconnected to one of said plurality of security devices;
a control center having a host device positioned remotely from said plurality of security devices; and
a single central transceiving unit interconnected to said host device for wirelessly communicating with each of said plurality of wireless transceiving units.

8. The system of claim 7, wherein each of said plurality of wireless transceiving units is programmed to receive data from at least one of said plurality of security devices.

9. The system of claim 8, wherein each of said plurality of wireless transceiving units is programmed to append data representing said predetermined location to said data received from said security device.

10. The system of claim 9, wherein each of said plurality of wireless transceiving units is programmed to transmit said data representing said predetermined location along with said data received from said security device to said central wireless transceiving unit.

11. The system of claim 10, wherein said central wireless transceiving unit is programmed to identify said predetermined location based receipt of said data representing said predetermined location from at least one of said plurality of wireless transceiving units.

12. The system of claim 11, wherein said central wireless transceiving unit is programmed to output the identity of said predetermined location along with said data supplied by said security device to said host device.

13. The system of claim 12, wherein said host device is adapted to determine whether to grant access at said predetermined location based on the identity of said predetermined location and said data supplied by said security device.

14. The system of claim 13, wherein said host device is adapted to communicate the determination of whether to grant access at said predetermined location to said central wireless transceiving unit.

15. The system of claim 14, wherein said central wireless transceiving unit is programmed to transmit data representing the determination of whether to grant access to said predetermined location along with data representing said predetermined location to said plurality of wireless transceiving units.

16. The system of claim 15, wherein each of said plurality of wireless transceiving units is programmed to determine whether to actuate said security device based on receipt of said data representing the determination of whether to grant access to said predetermined location along with said data representing said predetermined location.

17. A method of controlling access in a security system, comprising the steps of:
receiving user data at a predetermined remote location;
combining said user data with data indicating said predetermined remote location;
wirelessly transmitting said user data with said data indicating said predetermined remote location to a central location;
receiving said user data and said data indicating said predetermined location at said central location;
determining whether to grant access to said predetermined remote location based on said user data and said data indicating said predetermined remote location; and
wirelessly transmitting said determination whether to grant access to said predetermined remote location to said predetermined remote location.

18. The method of claim 17, further comprising the step of retrieving data indicating said predetermined remote location prior to the step of combining said user data with data indicating said predetermined remote location.

19. The method of claim 18, wherein the step of wireless transmitting wirelessly transmitting said user data with said data indicating said predetermined remote location to a central location comprises transmitting said user data and said data indicating said predetermined remote location to a remote location in a single digital data packet.

20. The method of claim 18, wherein the step of wireless transmitting said user data with said data indicating said predetermined remote location to a central location comprises transmitting said user data and said data indicating said predetermined remote location to a central location in consecutive digital data packets spaced apart by a predetermined period of time.
